(19) United States
(12) Patent Application Publication
(10) Pub. No.: US 2003/0063234 A1
(43) Pub. Date: Apr. 3, 2003

(54) Surface lighting device

(76) Inventors: Masaharu Oda, Tokyo (JP); Rika Narumi, Kanagawa-ken (JP); Mitsuo Tsuji, Tokyo (JP)

Correspondence Address: McCormick, Paulding & Huber, City Place ll, 185 Asylum Street, Hartford, CT, 06103-3402, US

(21) Appl. No.: 10/202,561

(22) Filed: Jul. 23, 2002

(30) Foreign Application Priority Data
Jul. 25, 2001 (JP) 2001-225031

(51) Int. Cl. G02F 1/1335

(52) U.S. Cl. 349/65

(57) ABSTRACT

A surface lighting device including a light guiding plate (11) including two light incident surfaces (11a) formed at opposite end surfaces of the light guiding plate and a light exit surface (11b); two elongated light sources (12) that face the two light incident surfaces; and a reflector plate (14) positioned to face a rear surface of the light guiding plate, and to reflect light toward said light exit surface. The light guiding plate includes (i) alight projecting device (11d) that projects light from the light exit surface; (ii) a light quantity control device that controls a quantity of the light to be emitted, by the light projecting device, from the light exit surface; and (iii) a light condensing device (11e) that condenses the light to be emitted from the light exit surface.

### BACKGROUND OF THE INVENTION

1. Field of the Invention

The present invention relates to an edge-light type surface lighting device which is used for LCDs for, e.g., notebook/desktop personal computers and LCD TV sets and, in particular, relates to an edge-light type high-luminance surface lighting device having a wide viewing angle.

2. Description of the Related Art

In recent years, color LCDs have been widely used in various applications as information technology moves forward, and have been required to fill particular needs in response to the increase in quantity of information to be managed, diversity of needs, and multimedia compatibility. Specifically, there have been strong needs for production of high-luminance color LCDs having a wide viewing angle in various fields. Accordingly, color LCDs achieving a balance between high luminance and wide viewing angle have been in demand.

Current mobile notebook personal computers and another mobile devices that adopt a color LCD generally use a battery such as a rechargeable NiMH pack or a lithium-ion battery pack. Therefore, such a color LCD is preferably a low-power consumption type which extends the service life of the battery. Since the LCD (LCD panel) in itself does not emit light, the LCD needs to be used together with a lighting device which illuminates the LCD from behind. Accordingly, a surface lighting device is an essential backlight device for the LCD.

The construction of the surface lighting device can be roughly divided into two types: a direct type and an edge-light type.

In a direct type surface lighting device, a light source is placed under the LCD.

On the other hand, an edge-light type surface lighting device uses a straight lamp along an end face of the LCD, two lamps on opposite end faces of the LCD, or L-shaped lamps along the opposite corners of the LCD. The edge-light type has become more widespread than the direct type because the edge-light type is advantageous for reducing the power consumption and the size of an entire LCD device.

Even in the case of using an edge-light type surface lighting device, the surface lighting device itself consumes most of the power of the battery. Accordingly, it has been desirable to increase the efficiency of power consumption of the edge-light type surface lighting device, and to achieve higher luminance and a wider viewing angle with lower power consumption.

In response to such demands, Japanese laid-open patent publication No.2-17 discloses a new edge-light type surface lighting device. In this type of surface lighting device, a lens unit is formed directly on a light exit surface of a light guiding plate (which serves an element of the surface lighting device), while a prism sheet, on which an array of parallel prism projections each having a triangular cross section is formed, is positioned on the light guiding plate so that the prism array faces the light guiding plate. According to this construction, light, condensed by the lens unit, is emitted obliquely with respect to the light exit surface, and is subsequently directed by the prism sheet toward the front of the LCD device to thereby achieve high luminance.

Japanese laid-open patent publication No.4-9804 discloses another type of edge-light type surface lighting device having a light guiding plate on which linear projections and depressions are formed to extend in a direction substantially perpendicular to the light incident surface of the light guiding plate. According to this structure, the dispersion of light in a direction parallel to the light incident surface of the light guiding plate is condensed by the lens effect due to the linear projections and depressions to thereby achieve a high luminance.

However, in recent years, further enhancement of the luminance of the surface lighting device has been demanded. Namely, a surface lighting device which achieves a higher luminance than those disclosed in the aforementioned two Japanese laid-open patent publications has been demanded.

### SUMMARY OF THE INVENTION

The present invention is to provide a high-luminance surface lighting device with a wide viewing angle.

According to an aspect of the present invention, there is provided a surface lighting device including a light guiding plate including two light incident surfaces respectively formed at opposite end surfaces of the light guiding plate and a light exit surface formed on a front surface of the light guiding plate; two elongated light sources that face the two light incident surfaces, respectively; and a reflector plate positioned to face a rear surface of the light guiding plate, and to reflect light toward said light exit surface. The light guiding plate includes (i) a light projecting device that allows light emitted from the two elongated light sources and incident on the two light incident surfaces to project from the light exit surface; (ii) a light quantity control device that controls a quantity of the light to be emitted, by the light projecting device, from the light exit surface; and (iii) a light condensing device that condenses light to be emitted from the light exit surface.

The light projecting device includes a first array of parallel prism projections that are formed on the light exit surface of the light guiding plate to be parallel to the two elongated light sources. Each prism projection of the first array of parallel prism projections is composed of a triangular cross section, and an interior apex angle (α) of the each prism projection of the first array of parallel prism projections is in a range of 160° to 178°.

The light quantity control device can be formed so that the thickness of the light guiding plate decreases in a direction toward a center thereof.

The light condensing device includes a second array of parallel prism projections which are formed on the rear surface of the light guiding plate to extend in a direction perpendicular to the two elongated light sources. Furthermore, each prism projection of the second array of parallel prism projections is composed of a triangular cross section, and an interior apex angle (β) of each prism projection of the second array of parallel prism projections is in a range of 120° to 160°.

The surface lighting device can includes at least one light conversion member that controls an intensity distribution of light from the light exit surface of the light guiding plate. Furthermore, the light conversion member includes a deflector that deflects the light from the light exit surface of the light guiding plate in a desired direction. The deflector can includes an array of parallel prism projections, each of which comprises a triangular cross section. Moreover, the light conversion member can include a diffuser that diffuses the light from the light exit surface of the light guiding plate. Still further, the light conversion member can be composed of a light condensing device that condenses the light emerging from the light exit surface of the light guiding plate. The light condensing device includes an array of parallel prism projections each of which comprises a triangular cross section.

The light conversion member includes a polarization beam splitter that splits light thereon into two linear polarized light components perpendicular to each other to reflect one of the two linear polarized light components, while allowing the other of the two linear polarized light components to pass therethrough.

The light conversion member includes at least two of the following four members: a deflector; a diffuser; a light condensing device; and a polarization beam splitter.

The present disclosure relates to subject matter contained in Japanese Patent Application No.2001-225031 (filed on Jul. 25, 2001) which is expressly incorporated herein by reference in its entirety.

### BRIEF DESCRIPTION OF THE DRAWINGS

The present invention will be described below in detail with reference to the accompanying drawings in which:

FIG. 1 is a schematic exploded perspective view of an embodiment of an edge-light type surface lighting device according to the present invention;

FIG. 2 is a perspective view of a light guiding plate shown in FIG. 1;

FIG. 3 is a schematic diagram of the light guiding plate shown in FIGS. 1 and 2, showing the traveling directions of light rays which are incident on a light incident surface of the light guiding plate to enter the light guiding plate;

FIG. 4 is a schematic diagram of the light guiding plate and a reflector plate which are shown in FIG. 1, showing a light-condensing state in the case where an array of parallel prism projections is formed on a rear surface of the light guiding plate;

FIG. 5A is a schematic diagram of a light guiding plate and a straight lamp, showing a state of reflection of a light ray within the light guiding plate when the thickness thereof is t1 by way of example;

FIG. 5B is a view similar to that of FIG. 5A, showing a state of reflection of a light ray within the light guiding plate when the thickness thereof is t2 by way of example;

FIG. 6 is a schematic diagram of the light guiding plate and a light conversion member, showing a state of reflection of a light ray from the light guiding plate to be reflected through the light conversion member;

### DESCRIPTION OF THE PREFERRED EMBODIMENTS

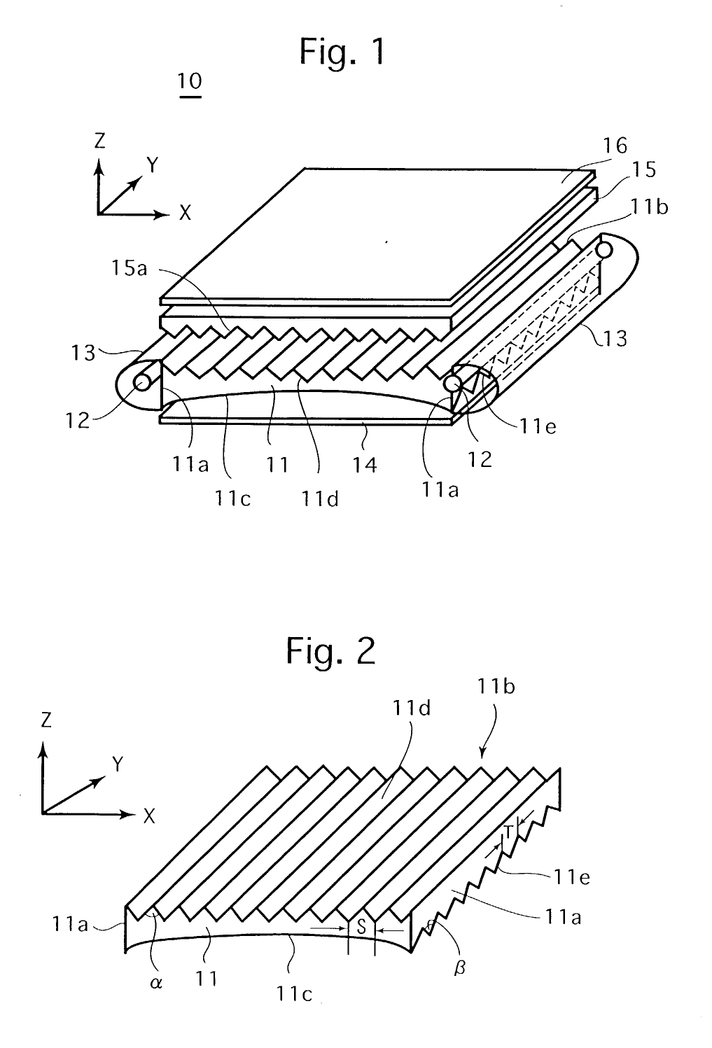

FIG. 1 shows an embodiment of an edge-light type surface lighting device according to the present invention. As shown in FIG. 1, the edge-light type surface lighting device 10, which serves as backlight for an LCD (LCD panel), is provided with a reflector plate 14, a light guiding plate 11, a first light conversion member 15 and a second light conversion member 16, in that order from the rear side to the front side (from bottom to top as viewed in FIG. 1). The surface lighting device 10 is further provided with two straight lamps (fluorescent tubes/elongated light sources) 12 and two reflectors 13. An LCD panel or an LCD module (not shown) is positioned immediately in front of the second light conversion member 16. The reflector plate 14 reflects light so that the angle of reflection of the light is equal to the angle of incidence thereof with respect to the normal at the point of incidence. The light guiding plate 11 is provided on each opposite end surfaces thereof with a light incident surface 11a. The two straight lamps 12 are positioned adjacent to the two light incident surfaces 11a and extend therealong, respectively. Each straight lamp 12 is surrounded by the associated reflector 13 having a substantially U-shaped cross section in a plane perpendicular to the axis of the straight lamp 12. Light which is emitted from each straight lamp 12 in a direction toward the associated light incident surface 11a is incident directly thereon, while light which is emitted from each straight lamp 12 in a direction away from the associated light incident surface 11a is reflected by the inner surface of the associated reflector 13, and thereafter, is incident on the associated light incident surface 11a.

The structure of the light guiding plate 11, which is a fundamental element of the surface lighting device 10, will be hereinafter discussed in detail with reference to FIG. 2. The light guiding plate 11 is formed in a rectangular shape, in plan view, having front and rear surfaces (top and bottom surfaces as viewed in FIG. 1) and four side end surfaces. The light guiding plate 11 is positioned to be parallel to the X-Y plane. Two of the four side end surfaces of the light guiding plate 11, which are positioned on opposite sides of the light guiding plate 11 and extend parallel to the Y-Z plane, constitute the light incident surfaces 11a.

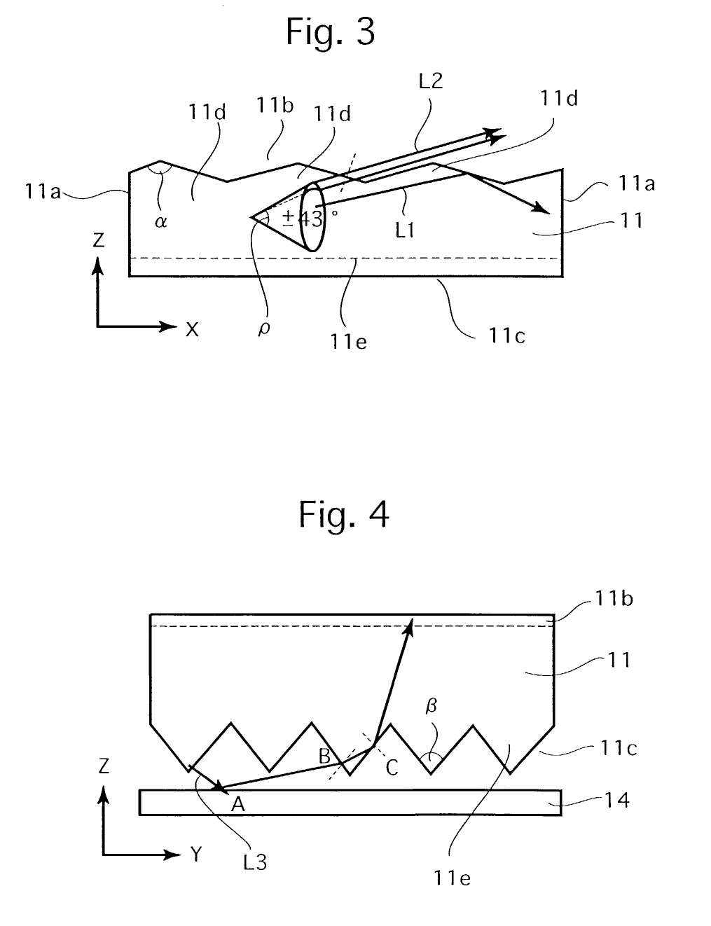

The front surface (the upper surface as viewed in FIG. 2) of the light guiding plate 11, which extends substantially perpendicular to each light incident surface 11a and substantially parallel to the X-Y plane, is formed as a light exit surface 11b. The light guiding plate 11 is provided on the light exit surface 11b thereof with a first array of parallel prism projections (first array of lens elements) lid which extend in a direction substantially parallel to the straight lamps 12 (i.e., in the Y-direction). The first array of parallel prism projections lid constitute a light projecting device which allows the light, emitted from the two straight lamps 12 and transmitted to the light guiding plate 11 through each of the two light incident surfaces 11a, to project from the light exit surface 11b toward the first light conversion member 15. Each prism projection of the first array of parallel prism projections lid has a triangular cross section, and the interior apex angle α (see FIG. 3) of each prism projection thereof is desirably in the range of 160° to 178° (more desirably in the range of 165° to 175°).

The light guiding plate 11 is provided on a rear surface (lower surface as viewed in FIG. 1) 11c thereof with a second array of parallel prism projections (second array of lens elements) lie which extend in a direction substantially perpendicular to the straight lamps 12, i.e., in the X-direction. Accordingly, the first and second arrays of parallel prism projections lid and lie extend in directions perpendicular to each other. The second array of lens elements lie serves as a light condensing device which condenses the light to be emitted from the light exit surface 11b. This increases the luminance of the surface lighting device 10. Each prism projection of the second array of parallel prism projections lie has a triangular cross section, and the interior apex angle β (see FIG. 2) of each prism projection thereof is desirably in the range of approximately 120° to 160°, more desirably in the range of approximately 130° to 140°.

It is desirable for the light projecting device formed on the light guiding plate 11 to be formed as an array of parallel prism projections (i.e., the first array of parallel prism projections 11d), but is not limited to such an array of prism projections.

The principle of the light projecting device, in the case where the light projecting device is formed as an array of parallel prism projections (i.e., the first array of parallel prism projections 11d), will be hereinafter discussed. As shown in FIGS. 1 through 3, the ridges of all the first array of parallel prism projections lid extend in a direction parallel to the two light incident surfaces 11a, i.e., in the Y-direction.

As shown in FIG. 3, the distribution of the light which is incident from each light incident surface 11a is within a solid angle ρ of approximately ±43° according to Snell's law, so that the light which is incident from each light incident surface 11a is totally reflected by an inner surface of the light guiding plate 11 to travel within the light guiding plate 11. In the case where an array of lens elements (the first array of parallel prism projections lid) are formed on the front surface of the light guiding plate 11, if an angle of a light ray with respect to an inner surface of a prism projection (lid) is close to the critical angle, the angle may exceed the critical angle in accordance with the amount of the vertex angle of the prism projections lid, so that the light ray is emitted from the light exit surface 11b. In FIG. 3, a light ray L2 represents such an emerging light ray; and a light ray L1 represents one which strikes an inner surface of a prism projection at an angle smaller than the critical angle. Even a light ray like L1, which changes its traveling direction by the first array of parallel prism projections 11d toward the inner side of the light guiding plate 11 (see FIG. 3), may strike an inner surface of a prism projection of a subsequent first array of parallel prism projections 11d at an angle exceeding the critical angle.

Accordingly, if the first array of prism projections lid are formed on the front surface of the light guiding plate 11 (i.e., the light exit surface 11b), light rays emitted one after another from the light guiding plate 11 through the light exit surface 11b.

In the case where an array of parallel prism projections (i.e., the first array of prism projections lid) is employed as array of lens elements constituting the light projecting device of the light guiding plate 11, the interior apex angle α (see FIG. 2) of each prism projection is, as explained, necessary to be in the range of 160° to 178° (more desirably in the range of 165° to 175°). This is because of the following reasons:

(i) If the interior apex angle α is smaller than 160°, the proportion of light rays which are incident on the light exit surface 11b at an angle of incidence greater than the critical angle increases. Therefore, the luminance of the surface light device 10 becomes higher in the vicinity of each straight lamp 12, and sharply drops in a direction away from each light incident surface 11a toward the center of the light guiding plate 11. Consequently, the surface lighting device 10 emits backlight of insufficient luminance distribution. (ii) If the interior apex angle α is larger than 178°, the proportion of light rays which are incident on the light exit surface 11b at an angle of incidence greater than the critical angle decreases. Consequently, the surface lighting device 10 emits dark backlight.

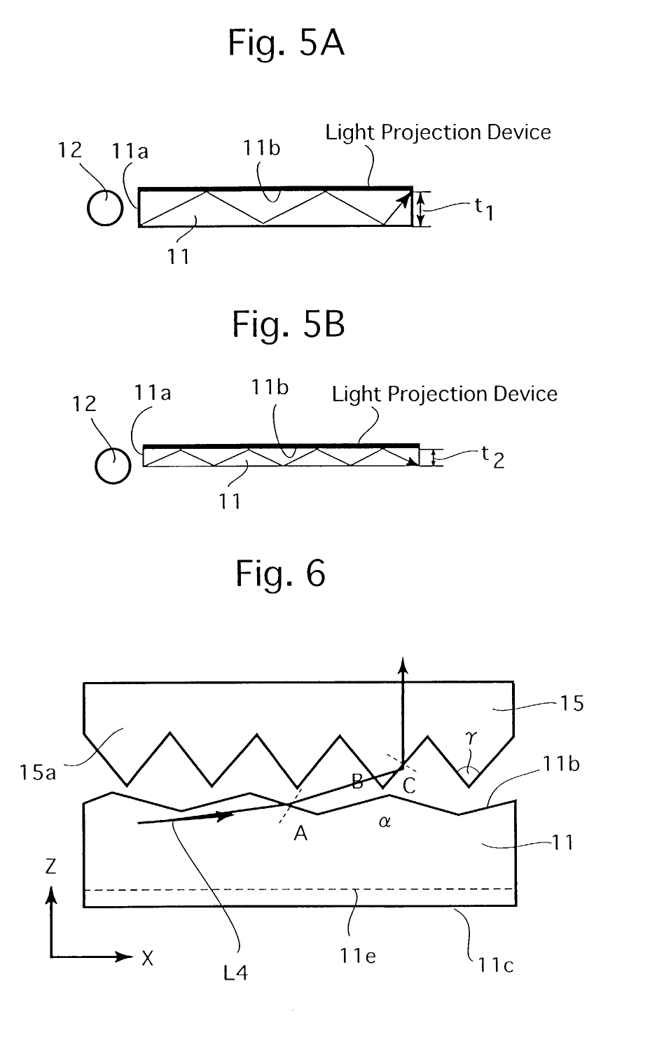

The light guiding plate 11 incorporates a light quantity control device which controls the quantity of light to be emitted from the light exit surface 11b. The light quantity control device is constituted by forming the light guiding plate 11 to have an uneven thickness. The principle of operation of this structure will be hereinafter discussed in detail with reference to FIGS. 5A and 5B. In these figures, note that the first array of parallel prism projections lid, which are formed on the light exit surface 11b as the light projecting device, are indicated by a thick solid line. As shown in FIG. 5A, if the light guiding plate 11 has the thickness t1, the number of reflections of a light ray in the light guiding plate 11 is fewer. This decreases the quantity of light incident on the light projecting device (the light exit surface 11b), which reduces the rate of emergence of light rays from the light projecting device (the light exit surface 11b).

On the other hand, as shown in FIG. 5B, if the light guiding plate 11 has the thickness t2 smaller than t1, the number of reflections of a light ray in the light guiding plate 11 is larger. This increases the quantity of light incident on the light projecting device (the light exit surface 11b), which increases the rate in emergence of light rays from the light projecting device (11b).

The light quantity control device of the light guiding plate 11 utilizes the basic principle shown in FIGS. 5A and 5B to control the quantity of light rays emerging from the light exit surface 11b by constructing the light guiding plate 11 so as to have an uneven thickness. Specifically, as can be seen in FIG. 2, the light quantity control device is such that the thickness of the light guiding plate 11 is largest at each of the two light incident surfaces 11a, that the thickness thereof gradually decreases in a direction toward the center of the light guiding plate 11, and that the thickness of the light guiding plate 11 is smallest at the center of the light guiding plate 11. In other words, the number of reflections is made larger at the center of the light guiding plate 11, and the number of reflections is made smaller at the periphery thereof.

With such a light quantity control device, since the thickness of the light guiding plate 11 gradually decreases in a direction toward the center thereof, the light ray which enters the light guiding plate 11 through each light incident surface 11a is emitted from the light exit surface 11b efficiently to thereby achieve a backlight wherein the average luminance thereof is higher on the light exit surface 11b. Specifically, as shown in FIG. 2, the light guiding plate 11 is formed so that a ridge line of each prism projection lie becomes a concave arc line or a concave parabolic line between the two light incident surfaces 11a, i.e., the rear surface 11c of the light guiding plate 11 is formed as a concave curved surface. According to this structure, since there is no occurrence of a brighter area on the center of the light exit surface 11b, a high-quality backlight without uneven luminance distribution is achieved.

Although the first array of lens elements lid that serves as the light projecting device and the second array of lens elements lie that serves as the light condensing device are formed on the front surface (the light exit surface 11b) and the rear surface 11c of the light guiding plate 11, respectively, the first array of lens elements 11d and the second array of lens elements 11e can be formed on the rear surface and the front surface of the light guiding plate 11, respectively.

The light condensing device of the light guiding plate 11 is desirably formed by the second array of parallel prism projections 11e which extend in a direction substantially perpendicular to the straight lamps 12; however, the light condensing device can be formed by any other structures producing a similar optical effect such as a structure of the light guiding plate wherein an anisotropic hollow portion is formed inside the light guiding plate 11.

FIG. 4 shows a light-condensing state in the case where the second array of parallel prism projections 11e as an array of lens elements is formed on the rear surface 11c of the light guiding plate 11. A light ray L3 which is emitted from the rear surface 11c toward the reflector plate 14 is reflected thereby to reenter the light guiding plate 11 after being refracted by a surface of a prism projection lie at a point B. Subsequently, the light ray L3 is totally reflected by the other surface of the same prism projection lie at a point C, so that the light ray L3 changes the traveling direction thereof to exit from the light exit surface 11b as a condensed light ray traveling toward the LCD panel, which is positioned immediately in front of the first and second light conversion members 15 and 16. As long as the interior apex angle β of each prism projection of the second array of parallel prism projections 11e is within the above-explained desirable range (about 120° to 160°, desirably about 130° to 140° ), each of those two surfaces of a prism projection of the second array of parallel prism projections 11e can be formed as a curved surface. Even with such a structure, similar light-condensing effects can be obtained. In addition, if each of such two surfaces is formed as a curved surface, the second array of parallel prism projections lie can be easily formed on the light guiding plate 11, and at the same time, damages (e.g., scratches, etc.) on the surface lighting device 10 during assembly thereof can be prevented.

As shown in FIG. 1, the first light conversion member 15 is positioned immediately in front of the light exit surface 11b of the light guiding plate 11 to be parallel to the X-Y plane. The first light conversion member 15 is formed as a deflector (deflection sheet) which orients the light rays which are obliquely emitted from the light guiding plate 11 to a desired direction, in particular, toward the front of the surface lighting device 10. In the illustrated embodiment of the surface lighting device 10, such a deflector is composed of an array of parallel prism projections (deflector) 15a which extend in a direction substantially parallel to the straight lamps 12. Accordingly, the first conversion member 15 in the illustrated embodiment is formed to serve as a prism sheet. The array of parallel prism projections 15a are formed on a rear surface (light incident surface) of the first light conversion member 15 with the apexes of the prism projections facing toward the light guiding plate 11.

FIG. 6 shows a state where a light ray, which is incident on the first light conversion member 15 in a direction oblique to the normal with respect to the surface lighting device 10 (i.e., in the Z-direction), is totally reflected by a prism projection of the array of parallel prism projections 15a of the first light conversion member 15. More specifically, a light ray L4 is emitted from the light exit surface 11b of the light guiding plate 11 at a point A, and incident on a surface of a prism projection of the prism projections 15a at a point B, and is totally reflected by the other surface of the same prism projection 15a at a point C. As a result, the light ray L4 changes the traveling direction thereof so as to exit from the front surface of the first light conversion member 15 in the Z-direction. This achieves a high-efficiency surface lighting device without uneven luminance distribution, which corresponds to the luminance distribution of the light emitted from the light exit surface 11b of the light guiding plate 11. Each prism projection of the array of parallel prism projections 15a has a substantially triangular cross section, and the interior apex angle γ (see FIG. 6) of each prism projection of the array of prism projections 15a is desirably in the range of 50° to 70°, more desirably in the range of 60° to 70°. If the interior angle γ is within this range, the light rays, emitted from the light exit surface 11b of the light guiding plate 11 and incident on the first light conversion member 15, is totally reflected thereby to travel in a desired direction efficiently.

The array of prism projections 15a is formed on the rear surface of the first light conversion member 15 in the illustrated embodiment; however, the array of prism projections 15a can be formed on the front surface of the first light conversion member 15. In this case, the array of parallel prism projections 15a serves as a light condensing device which condenses the light, which is emitted from the light guiding plate 11 and enters the first light conversion member 15, is refracted by the array of prism projections 15a to travel in a direction toward the front of the surface lighting device 10. When the array of prism projections 15a serves as a light condensing device, the interior apex angle of each prism projection is desirably in the range of approximately 80° to 100°, and more desirably in the range of approximately 85° to 95°.

Although composed of the array of prism projections 15a in the illustrated embodiment, the first light conversion member 15 can be composed of any other optical element as long as the optical element changes the traveling direction of the light which is emitted from the light guiding plate 11 in a desired direction, e.g., in a direction of the normal with respect to the surface lighting device 10, i.e., the Z-direction. For instance, the first light conversion member 15 can be composed of a lenticular having an arc cross section or a fly-eye lens array.

The second light conversion member 16 shown in FIG. 1 is formed as a diffuser (diffusion sheet) which diffuses the light which is emitted from the light guiding plate 11 to enter the second light conversion member 16 via the first light conversion member 15. If the second light conversion member 16 is not incorporated in the surface lighting device 10, the following problems arise, since the first light conversion member 15 merely projects the light from the light guiding plate 11 toward the front of the surface lighting device 10:

(a) the angle of dispersion of the outgoing light from the surface lighting device 10 becomes narrower to thereby reduce the viewing angle of the surface lighting device 10;

(b) the luminance distribution of the surface lighting device 10 becomes uneven if the intensity of the light emitted from the light exit surface 11b of the light guiding plate 11 is uneven; and

(c) the image quality of the surface lighting device 10 deteriorates if any scratches or dust exits on the light exit surface 11b of the light guiding plate 11.

As explained, the second light conversion member 16 as a diffuser can increase the viewing angle, improve the uneven luminance distribution of the surface lighting device, and achieve a high-quality surface lighting device, in accordance with the intended use The diffusibility of the second light conversion member 16 is preferably 30 through 90 percents in haze factor, and can be determined in accordance with the intended use.

The second light conversion member 16 can be formed as a polarization beam splitter (PBS) instead of a diffuser. This polarization beam splitter splits the light, which is emitted from the light guiding plate 11 and is incident on the second light conversion member 16 via the first light conversion member 15, into two linear polarized light components perpendicular to each other to reflect one of the two linear polarized light components, while allowing the other linear polarized light component to pass through. Since this second light conversion member 16 as a polarization beam splitter can be arranged to allow only one of the two linear polarized light components to pass through in the direction of the normal with respect to the surface lighting device 10 (i.e., in the Z-direction), a highly-efficient surface lighting device is achieved, corresponding to intensity distribution of the light emitted from the light exit surface 11b of the light guiding plate 11.

Here, it is noted that the polarization beam splitter can be either one of the following first and second types.

The first-type polarization beam splitter allows one of the two linear polarized light components to pass through. The polarization direction of the light passed through is coincident with that of a rear polarizing plate (not shown) of the LCD panel, and at the same time reflects the other linear polarized light component back to the light guiding plate 11 to reuse the same.

The second-type polarization beam splitter allows one of the two linear polarized light components to pass through. The polarization direction of the light passed through is coincident with that of a rear polarizing plate (not shown) of the LCD panel. At the same time, the second-type polarization beam splitter changes the polarization direction of the other linear polarized light component to be identical to that of the one linear polarized light component of the light passed through, so that the other linear polarized light component passes through the second light conversion member 16 together with the one linear polarized light component.

A typical liquid crystal display (LCD) system is generally constructed from an LCD (LCD panel) and a surface lighting device. In such an LCD panel, a liquid crystal is sealed between two glass substrates on which electrodes are respectively formed, while these glass substrates are held between two polarizing plates (front and rear polarizing plates). Here, note that the polarization directions of the two polarizing plates are normal to each other. Only one of the two linear polarized light components of the natural light emitted from the surface lighting device passes through the rear polarizing plate while the other polarized light component is absorbed by the rear polarizing plate. The polarization direction of the one linear polarized light component of the natural light which passes through the rear polarizing plate is rotated due to a twist of liquid crystal molecules, and the one linear polarized light component is incident on the front polarizing plate. The amount of twist of liquid crystal molecules is controlled by voltage applied between each pair of electrodes, thereby how the polarization direction is rotated is determined. The light passed through the sealed-in liquid crystal passes through the front polarizing plate if the polarization direction of the light passed through the sealed-in liquid crystal is coincident with the polarization direction of the front polarizing plate. On the other hand, the light passed through the sealed-in liquid crystal is absorbed by the front polarizing plate if the polarization direction of the light passed through the sealed-in liquid crystal is normal to the polarization direction of the front polarizing plate. The LCD operates on such a principle. Accordingly, the transmittance of the natural light emitted from the surface lighting device to pass through the LCD panel is 50% at the maximum in conventional LCDs, since only one of the two linear polarized light components of the natural light incident on the rear polarizing plate passes therethrough. Therefore, in conventional LCDs, even if a high-luminance surface lighting device is used, half of the amount of light emitted therefrom is absorbed by the rear polarizing plate.

Unlike an LCD with a conventional surface lighting device, according to the surface lighting device 10 of the present embodiment, the transmittance of the natural light passing through the LCD panel is more than 50%. This is because the second light conversion member 16 as a polarization beam splitter can be formed as either the aforementioned first type polarization beam splitter or the aforementioned second type polarization beam splitter.

More specifically, if the second light conversion member 16 constituted by one of the above two types of the polarization beam splitters is employed in the surface lighting device 10 of an LCD, the light transmittance of the rear polarizing plate can be improved to be more than 50%. Consequently, an LCD using backlight with high efficiency can be achieved.

The two types of light conversion members (the first and second conversion members 15 and 16) are employed; however, the present invention is not limited to this particular embodiment. For instance, only one of the first and second conversion members 15 and 16 can be employed in the surface lighting device. In addition, at least two of the above described three types of members (the deflector, the diffuser and the polarization beam splitter) can be combined to be employed in the surface lighting device.

As shown in FIG. 1, each straight light 12 is a linear light source arranged to extend in the Y-direction. The straight light 12 can be, e.g., a fluorescent lamp or a cold-cathode lamp. Each reflector 13 reflects the light from the associated straight lamp 12 to be incident on the associated light incident surface 11a of the light guiding plate 11 to thereby reduce light loss of the straight lamp 12. The base material of each of the light guiding plate 11 and the first and second light conversion plates 15 and 16 can be a synthetic resin having a high light transmittance. Such a synthetic resin can be one of the following resins: a methacrylic resin, an acrylic resin, a polycarbonate resin, a polyester resin and a polyvinyl chloride resin. The surface structure of each of the light guiding plate 11 and the rear light conversion member 15, such as an array of parallel prism projections, can be formed by hot-pressing a transparent synthetic-resin plate with a stamping die having the corresponding surface structure, or can be formed concurrently through a screen printing process, an extrusion molding process or an injection molding process. At this time, the material of the surface structure can be hardened by heat if a thermosetting synthetic resin and the like is used, or by light (e.g., ultraviolet rays) if a light-curing type (e.g., ultraviolet-curing type) resin is used as the material of the surface structure.

Additionally, each of the first and second arrays of lens elements 11d and lie of the light guiding plate 11 can be formed by forming an array of lens elements of an activation-energy-beam curing resin on a transparent base (e.g., a transparent film or sheet) Likewise, the array of prism projections 15a of the first light conversion member 15 can be formed by forming an array of prism projections of an activation-energy-beam curing resin on a transparent base (e.g., a transparent film or sheet). In either case, such a transparent base can be laminated on another transparent base. Moreover, the transparent base can be cemented or fusion-bonded to another transparent base.

The present invention will further be described in detail with reference to a practical example and comparative examples 1 through 5.

### PRACTICAL EXAMPLE

A 15-inch (316 mm×240 mm×6 mm) diagonal plate is used as the light guiding plate 11. A niobium-electrode cold-cathode tube made by Sanken Electric Co., Ltd. is used as the straight lamp 12, and is activated to generate a high-frequency discharge with a current of 6.5 mA (the sum of the current from the two straight lamps 12) by an inverter made by TDK Corporation. The area of the 15-inch rectangular screen is divided into 81 sections (squares) (9×9 box matrix) to measure the average intensity of the 81 squares. When measuring the average intensity of the 81 squares, an X-Y automatic luminance distribution measuring system made by International Manufacturing & Engineering Services Co., Ltd. and a luminance meter (product number: BM-7) made by Topcon Corporation are used to measure the average luminance. This average luminance is defined as the brightness of the surface lighting device.

The value of “Imax/Imin” is defined as the uniformity ratio of luminance, wherein “Imax” and “Imin” designate the maximum luminance and the minimum luminance among all the above 81 sections.

A sheet of black paper provided at the center thereof with a pin hole having a diameter of 4 mm is placed facing toward the surface lighting device so that the position of the pin hole is aligned with the center of the 15-inch screen of the surface lighting device. The surface lighting device is mounted on a tiltable table which can be tilted by an angle of ±90° from a horizontal position. In a state where the tiltable table is in a horizontal position, the luminance meter (BM-7) is disposed with respect to the surface lighting device so that the diameter of the projected pin hole on the surface lighting device becomes 8 to 9 mm. A relative luminous intensity distribution of the light emitted from the light exit surface 11b is measured with the luminance meter while the tiltable table is rotated stepwise at intervals of 10 from ±80° to −80° in a direction parallel and normal to each straight lamp 12. A half angle of the dispersion of the measured relative luminous intensity distribution is defined as the half width distribution of the relative luminous intensity distribution.

The 15-inch light guiding plate 11 is made of an acrylic resin. An array of parallel prism projections, which serves as the first array of prism projections 11d, is formed, as the light projecting device, on the light exit surface 11b thereof with a diamond cutting tool so that the ridges of all the prism projections lid extend in a direction parallel to a major side (316 mm) of the light guiding plate 11, i.e., in a direction parallel to the light incident surfaces 11a (i.e., in the Y-direction). At this time, the interior apex angle α of each prism projection of the first array of parallel prism projections lid is set to 170°, while the pitch S of prism projections of the first array lid is set to 50 μm.

On the other hand, as the light quantity control device, the rear surface of the light guiding plate 11 is cut to be a concave curved surface having a radius of curvature of 2,398 mm. Thereafter, an array of parallel prism projections, which serves as the second array of prism projections 11e, is formed, as the light condensing device, on the rear surface of the light guiding plate 11 with a diamond cutting tool so that the ridges of all the prism projections lie extend in a direction parallel to a minor side (240 mm) of the light guiding plate 11. i.e., in a direction perpendicular to the light incident surfaces 11a (i.e., in the X-direction). At this time, the interior apex angle β of each prism projection of the second array of prism projections lie is set to 130°. The pitch T of prism projections of each array of the second array lie is set to 50 μm.

Two cold-cathode lamps, which serve as the two straight lamps 12, are positioned to face the two light incident surfaces 11a and to extend therealong, respectively.

A high-luminance reflection sheet made by TSUJIDEN Co., Ltd., which serves as the reflector plate 14, is positioned behind the light guiding plate 11 to face the second array of parallel prism projections 11e thereof. An inner surface of each reflector 13, positioned around each straight lamp 12, is provided with a diffusion sheet made by MITSUBISHI PLASTICS, INC. (trade name “ALSWET”) A prism sheet made by MITSUBISHI RAYON CO., LTD. (trade name “DIA ART”), which has the interior apex angle γ (see FIG. 6) of 65° and which serves as the first light conversion member 15, is positioned immediately in front of the light guiding plate 11 so that the array of parallel prism projections 15a face toward the light exit surface 11b of the light guiding plate 11, and so that the ridges of all the prism projections 15a extend in a direction parallel to the straight lamps 12. A diffusion sheet (production number: D117T) made by TSUJIDEN Co., Ltd., which serves as the second light conversion member 16, is mounted on the front surface of the first light conversion member 15.

### COMPARATIVE EXAMPLE 1

A light guiding plate of Comparative Example 1 is not provided on a rear surface thereof with light condensing device, i.e., an array of prism projections in which the interior apex angle of each prism projection is set at 130° (corresponding to the second array of prism projections 11e in Practical Example) is not constituted on the light guiding plate thereof.

Table 1 shows the luminance at a central portion of the light guiding plate 11 and the half width distribution of the luminous intensity in a direction parallel to the straight lamps 12 in Practical Example and each of Comparative Examples 1, 2, 3 and 5.

TABLE 1

| | | Half Width |
|---|---|---|
| | | Distribution |
| | Central | Angle of |
| | Luminance | the Luminous |
| | (Cd/m²) | Intensity (°) |
| Practical Example | 2860 | 42.4 |
| Comparative Example 1 | 1800 | 80.0 |
| Array of Prism Projections not | | |
| provided on Rear Surface of | | |
| Light Guiding Plate | | |
| Comparative Example 2 | 2150 | 62.5 |
| An Array of Prism Projections | | |
| (β = 110°) provided on Rear | | |
| Surface of Light Guiding Plate | | |
| Comparative Example 3 | 2510 | 61.8 |
| An Array of Prism Projections | | |
| (β = 165°) provided on Rear | | |
| Surface of Light Guiding Plate | | |
| Comparative Example 5 | 2290 | 43.5 |

As seen in Table 1, in Comparative Example 1 having no light condensing device, the central luminance on the light guiding plate is 1800 Cd/m², and the half width distribution of the luminous intensity is 80.0°. In addition, as a result of a visual inspection of the light exit surface of the light guiding plate, the light in a direction parallel to the straight lamps 12 is excessively dispersed out, which results in a low luminance.

Unlike such results of Comparative Example 1, in the surface lighting device of Practical Example, the central luminance on the light guiding plate is 2860 Cd/m², and the half width distribution of the luminous intensity is and 42.4°. In addition, as a result of a visual inspection, the light in a direction parallel to the straight lamps 12 is gathered to achieve high luminance.

### COMPARATIVE EXAMPLE 2

The surface lighting device of Practical Example is compared with that of Comparative Example 2 which is identical to Practical Example except that the interior apex angle β and the pitch T of an array of prism projections corresponding to the second array of prism projections 11e (see FIG. 2), as the light condensing device, are set at 110° and 50 μm in the light guiding plate so that the ridges of the prism projections extend in a direction parallel to a minor side (240 mm) of the light guiding plate.

As seen in Comparative Example 2 of Table 1, the central luminance on the light guiding plate is 2150 Cd/m², and the half width distribution of the luminous intensity is 62.5°.

### COMPARATIVE EXAMPLE 3

The surface lighting device of Practical Example is compared with that of Comparative Example 3 which is identical to Practical Example except that the interior apex angle β and the pitch T of an array of prism projections corresponding to the second array of prism projections lie (see FIG. 2), as the light condensing device, are set at 165° and 50 μm in the light guiding plate so that the ridges of the prism projections extend in a direction parallel to a minor side (240 mm) of the light guiding plate.

As seen in Comparative Example 3 of Table 1, the central luminance on the light guiding plate is 2510 Cd/m², and the half width distribution angle of the luminous intensity is 61.8°.

As seen in Table 1, the results of each of Comparative Examples 2 and 3 are apparently improved by providing the prism array as the light condensing device, as compared with the results of Comparative Example 1.

However, the interior apex angle β of the array of prism projections corresponding to the second array of prism projections 11e in each of Comparative Examples 2 and 3 is out of the above mentioned preferable range of approximately 120° to 160°. Consequently, as a result of a visual inspection, the light in a direction parallel to the straight lamps 12 is excessively dispersed as compared with Practical Example, which results in a low luminance.

### COMPARATIVE EXAMPLE 4

The surface lighting device of Practical Example is compared with that of Comparative Example 4 which is identical to Practical Example except that the interior apex angle α and the pitch T of an array of prism projections corresponding to the first array of prism projections lid (see FIG. 2), as the light projecting device, are set at 155° and 50 μm in the light guiding plate so that the ridges of the prism projections extend in a direction parallel to a major side (316 mm) of the light guiding plate.

On the other hand, the interior apex angle β of an array of prism projections corresponding to the second array of prism projections 11e (see FIG. 2), as the light condensing device, are maintained at 130° in the light guiding plate as Practical Example so that the ridges of the prism projections extend in a direction parallel to a minor side (240 mm) of the light guiding plate. Table 2 shows the above-defined uniformity ratio of luminance in Example 1 and Comparative Example 4.

TABLE 2

| | Uniformity Ratio of |
|---|---|
| | luminance |
| Practical Example | 0.75 |
| Comparative Example 4 | 0.30 |
| An Array of Prism | |
| Projections (α = 155°) | |
| provided on Front Surface of | |
| Light Guiding Plate | |

As seen in Table 2, the uniformity ratio of luminance, which is measured on the side of the light exit surface of the light guiding plate, is 0.30 in Comparative Example 4, whereas the uniformity ratio of luminance, which is measured on the side of the light exit surface 11b of the light guiding plate 11, is 0.75 in Practical Example. Accordingly, the uniformity ratio of luminance in Practical Example is improved more than double as the uniformity ratio of luminance in Comparative Example 4. This is because the interior apex angle α of the array of prism projections corresponding to the first array of prism projections 11d in Comparative Example 4 is out of the abovementioned preferable range of about 160° to 178°. Accordingly, the uniformity ratio of luminance in Comparative Example 4 is inferior to the uniformity ratio of luminance in Practical Example.

### COMPARATIVE EXAMPLE 5

The surface lighting device of Practical Example is compared with that of Comparative Example 5 which is identical to Practical Example except that the interior apex angle α and the pitch T of an array of prism projections corresponding to the first array of prism projections lid (see FIG. 2), as the light projecting device, are set at 170° and 50 μm in the light guiding plate so that the ridges of the prism projections extend in a direction parallel to a major side (316 mm) of the light guiding plate.

Furthermore, the interior apex angle β of an array of prism projections corresponding to the second array of prism projections 11e (see FIG. 2), as the light condensing device, are set at 130° in the light guiding plate so that the ridges of the prism projections extend in a direction parallel to a minor side (240 mm) of the light guiding plate.

As seen in Comparative Example 5 of Table 1, in the light guiding plate in which the light quantity control device is not formed thereon, the central luminance of the light guiding plate is 2290 Cd/M², and the half width distribution of the luminous intensity is 43.5° In this case, the amount of light emerging from the front surface of the light guiding plate reduces, resulting in a low luminance.

As can be understood from the foregoing, according to the present invention, a high-luminance surface lighting device with a wide viewing angle is achieved.

Obvious changes may be made in the specific embodiment of the present invention described herein, such modifications being within the spirit and scope of the invention claimed. It is indicated that all matter contained herein is illustrative and does not limit the scope of the present invention.

What is claimed is:

1. A surface lighting device comprising:
a light guiding plate comprising two light incident surfaces respectively formed at opposite end surfaces thereof and a light exit surface formed on a front surface thereof;
two elongated light sources that face said two light incident surfaces, respectively; and
a reflector plate positioned to face a rear surface of said light guiding plate, and to reflect light toward said light exit surface,
wherein said light guiding plate comprises:
a light projecting device that allows light emitted from said two elongated light sources and incident on said two light incident surfaces to project from said light exit surface;
a light quantity control device that controls a quantity of said light to be emitted, by said light projecting device, from said light exit surface; and
a light condensing device that condenses said light to be emitted from said light exit surface.

2. The surface lighting device according to claim 1, wherein said light projecting device comprises a first array of parallel prism projections that are formed on said light exit surface of said light guiding plate to be parallel with said two elongated light sources.

3. The surface lighting device according to claim 2, wherein each prism projection of said first array of parallel prism projections comprises a triangular cross section, and wherein an interior apex angle of said each prism projection is in a range of 160° to 178°.

4. The surface lighting device according to claim 1, wherein said light quantity control device is formed so that the thickness of said light guiding plate decreases in a direction toward a center thereof.

5. The surface lighting device according to claim 1, wherein said light condensing device comprises a second array of parallel prism projections which are formed on said rear surface of said light guiding plate to extend in a direction perpendicular to said two elongated light sources.

6. The surface lighting device according to claim 5, wherein each prism projection of said second array of parallel prism projections comprises a triangular cross section, and wherein an interior apex angle of each prism projection is in a range of 120° to 160°.

7. The surface lighting device according to claim 1, further comprising at least one light conversion member that controls an intensity distribution of light emerging from said light exit surface of said light guiding plate.

8. The surface lighting device according to claim 7, wherein said at least one light conversion member comprises a deflector that deflects said light from said light exit surface of said light guiding plate in a desired direction.

9. The surface lighting device according to claim 8, wherein said deflector comprises an array of parallel prism projections, each of which comprises a triangular cross section.

10. The surface lighting device according to claim 7, wherein said at least one light conversion member comprises a diffuser that diffuses said light from said light exit surface of said light guiding plate.

11. The surface lighting device according to claim 7, wherein said at least one light conversion member comprises a light condensing device that condenses said light emitted from said light exit surface of said light guiding plate.

12. The surface lighting device according to claim 11, wherein said light condensing device comprises an array of parallel prism projections each of which comprises a triangular cross section.

13. The surface lighting device according to claim 7, wherein said at least one light conversion member comprises a polarization beam splitter that splits light thereon into two linear polarized light components perpendicular to each other to reflect one of said two linear polarized light components, while allowing the other of said two linear polarized light components to pass therethrough.

14. The surface lighting device according to claim 7, wherein said at least one light conversion member comprises at least two of the following four members:
a deflector that deflects said light from said light exit surface of said light guiding plate in a desired direction;
a diffuser that diffuses said light from said light exit surface of said light guiding plate;
a light condensing device that condenses said light from said light exit surface of said light guiding plate; and
a polarization beam splitter that splits light thereon into two linear polarized light components perpendicular to each other to reflect one of said two linear polarized light components while allowing the other of said two linear polarized light components to pass through said polarization beam splitter.

15. The surface lighting device according to claim 4, wherein said light quantity control device is further formed so that the thickness of said light guiding plate is greatest at each of said two light incident surfaces and smallest at a center of said light guiding plate.

16. The surface lighting device according to claim 9, wherein said array of parallel prism projections is formed on a rear surface of said first light conversion member, and wherein apexes of prism projections of said array of parallel prism projections face said light guiding plate.

17. The surface lighting device according to claim 10, wherein diffusibility of said second light conversion member is 30 through 90 percents in haze factor.

18. The surface lighting device according to claim 12, wherein an interior apex angle (γ) of said each prism projection of said array of parallel prism projections is in a range of 50° to 70°.

19. The surface lighting device according to claim 4, wherein said rear surface of the light guiding plate is formed as a concave curved surface.

20. A surface lighting device serving as backlight for an LCD panel, comprising:
two elongated light sources,
a reflector plate,
a light guiding plate,
a first light conversion member, and
a second light conversion member, in that order from rear to front of said surface lighting device,
wherein said light guiding plate comprises two light incident surfaces respectively formed at opposite end surfaces of said light guiding plate and a light exit surface formed on a front surface of said light guiding plate,
wherein said two elongated light sources are arranged on opposite sides of said light incident surfaces to face said two light incident surfaces of said light guiding plate, respectively,
wherein said reflector plate reflects incident light thereon toward said light guiding plate, and
wherein said light guiding plate comprises:
a first array of parallel prism projections which are formed on said light exit surface of said light guiding plate to be parallel to said two elongated light sources;
a second array of parallel prism projections which are formed on a rear surface of said light guiding plate to extend in a direction perpendicular to said two elongated light sources; and
a light quantity control device which controls a quantity of light to be emitted from said light exit surface of said light guiding plate to said LCD panel, wherein said light quantity control device is formed to gradually decrease the thickness of said light guiding plate in a direction toward a center thereof.
